(19) United States
(12) Patent Application Publication
(10) Pub. No.: US 2014/0267705 A1
(43) Pub. Date: Sep. 18, 2014

(54) APPARATUS FOR MEASURING FEED AMOUNT

(71) Applicants: Don Hankins, Friendswood, TX (US); John T. Polasek, Bellaire, TX (US)

(72) Inventors: Don Hankins, Friendswood, TX (US); John T. Polasek, Bellaire, TX (US)

(21) Appl. No.: 13/826,620

(22) Filed: Mar. 14, 2013

(51) Int. Cl. A01K 5/02; H04N 7/18; A01K 5/00

(52) U.S. Cl. CPC A01K 5/02; A01K 5/00; H04N 7/18
USPC 348/143; 119/51.01; 119/57.92

(57) ABSTRACT

An apparatus and methods are disclosed, exemplified by an ultrasonic transceiver that is contained within a feed container. The ultrasonic transceiver transmits ultrasound and receives reflected ultrasound to determine a value for the level of feed in a feed container. The apparatus measures the time difference from the transmission of the ultrasound to the receipt of reflected ultrasound. From this information, the distance from the ultrasonic transceiver to the top of the feed in the feed container can be computed. The distance measurement can then be correlated with the level of feed in the container. The feed level is represented by a series of LEDs on the exterior of the feed container. The feed level can also be transmitted to an individual to remotely determine the level of feed in the feeder. A two-way connection enables a remote user to dispense feed and/or check the level of the feed.

### BACKGROUND OF THE INVENTION

1. Field of Inventions

The apparatus described herein is related to an electronic device to measure the amount of feed in wildlife feeders. Other embodiments may relate to other applications, including monitoring activity near the feeder.

2. Description of Related Art

Wildlife feeders typically include a container (such as a barrel, bucket, drum, box, or other container). In most instances, the feeders may be mounted on a platform, raised via legs, suspended, or even placed on the ground. The container holds feed, such as corn. The feeder dispenses the feed to wildlife in the area. For example, feed can be dispersed through the use of a disk placed under a small hole in the bottom of the container. The disk is connected to a motor. In such a setup, the feed slowly drops through the hole in the bottom of the container, where the feed encounters the disk. Periodically, the motor is activated to rotate the disk for a period of time, thereby dispensing the feed. The feed may be dispersed laterally away from the feeder. Other methods of dispersing the feed involve the use of a tube inserted into or connected to the bottom of the feeder. Protein feeders commonly include such a design. Still yet, other feeders have an object, such as a rod, hanging from an opening in the bottom of the feeder that, when moved by an animal, will cause feed to fall from the container.

The feeder will inevitably be depleted of feed. Still yet, other times the feeder becomes clogged, or the feeding mechanism fails to operate (such as in the event of a battery failure). An individual that maintains a feeder (such as a hunter), in general, is unaware of the amount of feed remaining in the feeder, particularly where that individual is remote from the feeder. This results in that individual either not knowing when the feeder is empty or operating properly or improperly, and consequently the individual may purchase too much feed, which is wasteful, or too little feed.

It is therefore necessary for those individuals maintaining feeders to know the remaining feed in a feeder and refill it as necessary. Various approaches have been used in connection with determining the amount of feed in wildlife feeders. These prior approaches, described herein, have shortcomings that render them either unsafe, impractical, or time-consuming. A need therefore exists for an apparatus for safely and practically measuring the amount of feed in a wildlife feeder, as described herein.

One approach to measuring the amount of feed in a wildlife feeder involves physically opening the feeder and visually identifying the amount of feed remaining in the feeder. This approach is flawed for multiple reasons. As discussed above, this method requires that an individual frequently check the level of feed and be physically present to do so. If that individual is remote from the feeder, then it is inconvenient, time-consuming, and impractical to physically inspect the feeder. Further, feeders can be as tall as 12 feet. In order to physically inspect such a feeder, the person maintaining it would have to use a ladder. This can be very dangerous, particularly in adverse weather or for elderly or infirm individuals. This method is also time consuming, as it requires partial disassembly of the feeder.

Another approach to measuring the amount of feed remaining in a feeder involves the use of a clear window on the side of the feeder. The window allows the individual maintaining the feeder to visually observe the amount of feed without opening the feed container. This method is simpler than opening the feeder, but it still has drawbacks. For example, the window only shows whether feed is at the level of the window or above. Once the amount of feed is such that it does not rise to the level of the window, it is impossible to determine how much feed remains. In addition, this approach requires the individual maintaining the feeder to be physically present to inspect the amount of feed in the feeder. Also, if the feeder is elevated, a ladder may be required to inspect the amount of feed.

Another approach to measuring the amount of feed remaining in a feeder involves connecting the motor of the rotating disk to a timing device. The duration of rotation can then be determined, as well as how often the rotation is activated. This information is then used to indirectly provide a very rough estimate of how much feed remains in the feed container. For example, if the rotating disk is frequently activated and/or is activated for lengthy durations, then the timing device will report that the feed level is low. On the other hand, if the rotating disk is infrequently activated or is only active for short durations, the timing device may report that the feed level is high. This approach relies on estimations of the amount of feed and is very imprecise.

The approaches to feed measurement discussed above are impractical, imprecise, and potentially dangerous. Accordingly, there exists a need for a device to allow an individual to safely and easily determine the amount of feed in a feed container. There also exists a need for a system that allows an individual to remotely determine the amount of feed in the feeder.

### SUMMARY OF THE INVENTION

An apparatus is disclosed comprising a sensor, such as an ultrasonic sensor, as a further example such as an ultrasonic transceiver, that monitors the level of feed within a container. The sensor may be placed within a feed container. The sensor, such as the transmitter and receiver components of a transceiver are directed towards the feed in the feed container. In a preferred embodiment, the ultrasonic transceiver transmits signals and receives reflected signals that can be utilized to provide a value for the level of feed in a feed container. For example, the apparatus may measure the time difference from the transmission of the signal to the receipt of the reflected signal. From this information, the distance from the transceiver to the level of the feed in the feed container can be computed. The distance measurement can then be correlated with the level of feed in the container. For example, a longer distance measurement indicates that the feed level is lower, whereas a shorter distance measurement indicates that the feed level is higher. A variety of sensors can be used in this invention. For instance, other embodiments include a sensor to monitor light levels in the container or a weight-bearing sensor.

The apparatus may also include an output to indicate the feed level. For example, the feed level—as determined by the distance measurement—may be represented by a series of light emitting diodes (“LEDs”) positioned in a row or column on the exterior of the feed container. There can be any number of LEDs and they can be multicolored, or one color. In one embodiment, for a high level of feed (such as if the feeder is full), all of the LEDs would be lit. As feed is disbursed from the feeder, LEDs would successively become unlit, starting at the end of the row or column of LEDs. Once the feeder is “empty”, or nearly empty, all or most of the LEDs would be unlit or one or more LEDs could blink to signify an “empty” condition. In the embodiment in which the LEDs are multicolored, different colors can be used to represent varying levels of feed. For example, red LEDs represent low levels of feed, yellow LEDs represent moderate levels of feed, and green LEDs represent high levels of feed. Alternatively, a liquid crystal display (“LCD”) can be used to represent the level of feed graphically, with text, or both. Other displays could also be used to depict the level of feed in a variety of manners.

In another embodiment, the feed level can also be transmitted via a wireless or hard-wired data connection. This enables an individual to remotely determine the level of feed in the feeder. In such embodiment, the system would not be required to include a display at the feeder, although the system could include a display at the feeder. In another embodiment, a two-way connection enables the apparatus to receive instructions from a remote user, such as a user using a PC, desktop computer, tablet, or cellular phone, for example. Thus, a remote user can check the level of the feed, activate the rotating disk to dispense feed, adjust feeding parameters such as frequency of activation and duration of activation, and the like. In one embodiment, the system would be capable of sending a signal to an individual, such as via a text message or email to indicate the level of feed and/or that the feeder mechanism had been activated. Multiple feeders can be linked together to share a common connection. The data connection can further provide weather information to the remote user. In another embodiment a camera could be connected to the system to transmit pictures/video of the feeder and/or surrounding area that enable a user to monitor the wildlife at or near the feeder and to adjust feeding parameters as may be desired.

In another embodiment, the apparatus includes security features, to prevent interference with the feeder by undesired wildlife or people. In the event an animal disturbs the feeder, the apparatus can be configured to flash lights and/or activate an audible siren. Any activations of the alarm system will result in an email and/or SMS notification being transmitted over the data connection to a remote user.

In one aspect, the present invention may be an apparatus comprising: a wildlife feeder having a container adapted for holding wildlife feed; a feed level sensor mounted to the container and positioned to monitor and measure the level of feed in the container; and an output connected to the feed level sensor that displays the feed level. Another feature of this aspect of the invention may be that the output further comprises a plurality of light emitting diodes. Another feature of this aspect of the invention may be that the output further comprises a liquid crystal display. Another feature of this aspect of the invention may be that the apparatus further comprises: a communication device capable of transmitting a feed level value to a remotely-located communication device. Another feature of this aspect of the invention may be that that the apparatus further comprises a remotely-located communication device with an Internet-based application to output the feed level value. Another feature of this aspect of the invention may be that the apparatus further comprises a remotely-located communication device that receives the feed level value using a software application; and the software application outputs the feed level value. Another feature of this aspect of the invention may be that the apparatus further comprises a software application that permits control of a feed dispenser attached to said wildlife feeder from signals received from a remotely-located communication device. Another feature of this aspect of the invention may be that the apparatus further comprises a remotely-located communication device with a sensor that determines when undesired wildlife attempt to feed at said wildlife feeder.

In another aspect, the present invention may be a measurement apparatus for determining the feed level in wildlife feeders comprising: a transceiver, said transceiver emitting a signal; said transceiver receiving at least one reflected signal; a microprocessor that computes the distance from the transceiver to the feed level; said microprocessor computing a feed level value; said microprocessor providing a signal to an output; said output indicating the feed level value. Another feature of this aspect of the invention may be that the apparatus of further comprises one or more light emitting diodes. Another feature of this aspect of the invention may be that the apparatus further comprises a liquid crystal display to display the feed level value. Another feature of this aspect of the invention may be that the apparatus further comprises a communication device that transmits the feed level value to a remotely-located communication device. Another feature of this aspect of the invention may be the apparatus further comprises a remotely-located communication device; and an Internet-based application to output the feed level value. Another feature of this aspect of the invention may be that the apparatus further comprises said feed level value that is received remotely using a software application; and the software application outputs the feed level value. Another feature of this aspect of the invention may be that the apparatus further comprises a software application that permits control of a feed dispenser attached to said wildlife feeder from signals received from a remote device. Another feature of this aspect of the invention may be that the apparatus further comprises a sensor connected to an alarm, activated when said sensor detects tampering. Another feature of this aspect of the invention may be that the apparatus further comprises a camera, wherein video (including pictures) of at least one area surrounding said wildlife feeder captured by the camera are transmitted to a remotely-located communication device. Another feature of this aspect of the invention may be that the apparatus further comprises said communication device transmits to a remotely-locate communication device a signal to indicate whether said sensor has determined that undesired wildlife is near or attempted to feed at said wildlife feeder. Another feature of this aspect of the invention may be that the apparatus further comprises a camera, wherein video of at least one area surrounding said wildlife feeder captured by the camera are transmitted to a remotely-located communication device. Another feature of this aspect of the invention may be that the apparatus further comprises said communication device transmits to a remotely-locate communication device a signal to indicate whether said sensor has determined that undesired wildlife is near or attempted to feed at said wildlife feeder.

### BRIEF DESCRIPTION OF THE DRAWINGS

FIG. 1 is a cutaway diagram of a wildlife feeder with an apparatus for measuring the feed level installed in it.

FIG. 2 is a close-up diagram of the LED bank.

FIG. 3 is a close-up diagram of an ultrasonic transceiver.

FIG. 4 is a diagram of an embodiment of communications capabilities of the disclosed inventions.

FIG. 5 is a diagram of an embodiment of security features of the disclosed inventions.

FIG. 6 is a diagram of an embodiment in which a plate system may be used to determine the feed level.

FIG. 7 is a diagram of an embodiment in which a load or weight sensor may be used to determine the feed level.

FIG. 8 is a diagram of an embodiment in which an LCD screen is used to display the feed level.

FIG. 9 is a flowchart depicting the flow of an algorithm of an embodiment of the invention.

### DETAILED DESCRIPTION OF THE INVENTION

The following text sets forth a detailed description of several embodiments of the invention. However, it should be understood that the scope of the inventions is not limited to any particular embodiment disclosed herein. One skilled in the art would understand that alternative embodiments to those described herein could be implemented, based on this disclosure.

Wildlife feeders typically include a container (such as a barrel, bucket, drum, box, or other container). Typically, the container will also include a top, such as a removable top. In most instances, these feeders may be mounted on a platform, raised on “legs,” suspended, or even placed on the ground. The container holds an amount of feed, such as corn. Other types of feed may be used, as well. The feeder is capable of dispensing feed to wildlife in the area. The manner in which feed is dispensed is a matter of design choice. For example, feed can be dispersed through the use of a disk placed under a small hole in the bottom of the container. The disk is connected to a motor, which enables the disc to rapidly rotate. In such a setup, the feed slowly drops through the hole in the bottom of the container, where the feed encounters the disk. Periodically, the motor is activated to rotate, which causes the disk to rotate. The feed is then dispersed laterally away from the feeder. The feeder can dispense feed in this manner at periodic intervals, and can do so either automatically, for example on a preprogrammed basis, or when otherwise activated. Another method of dispersing the feed involve the use of a tube inserted into the bottom of the feeder. Feed drops out of the container and into the tube, and towards the end of the tube. Protein feeders commonly are generally constructed in this manner. Still yet, other methods of dispersing the feed exist, and would be known by one skilled in the art. Because the feeder disperses feed or makes feed available for consumption by wildlife, the feed level will gradually decrease. A device is needed such that an individual may conveniently and safely determine the amount of feed remaining in the feeder. The inventions disclosed herein satisfy this need.

FIG. 1 illustrates one particular embodiment of the claimed invention for measuring a feed level. FIG. 1 shows a cut-away view of feeder container 100, displaying the inside of the feeder container. While feeder container 100 is a cylindrically-shaped barrel in FIG. 1, feeder container 100 can be any shape or size. As shown in FIG. 1, feeder 100 has support legs 102. The configuration of support legs 102 is not important to the inventions disclosed herein. Feeder container 100 is shown in a cut-away view, so that the interior may be seen. Feed 104 lies at the bottom of feeder container 100. Any type of wildlife feed is compatible with the inventions disclosed herein. FIG. 1 also shows a tube positioned below the feeder container 100, to disperse feed. Other types of feed dispersal mechanisms are compatible with the inventions disclosed herein, including (without limitation) a motor with a rotating disk.

In FIG. 1, in a specific embodiment, a feeder sensor, such as an ultrasonic transceiver 108, is positioned inside feeder container 100, at or near the top. In a specific embodiment, the Ultrasonic transceiver 108 may include ultrasonic transmitter 110 and ultrasonic receiver 112. Ultrasonic transceiver 108 may be positioned such that signal transmission 114 and signal reflection 116 can be sent and received by the transceiver. In one embodiment, the transmitted and reflected signals are generally perpendicular to the level of the feed; however, the sensor may be positioned in such a manner that the transmitted and reflected signals are directed to another position within the container, such as inwardly towards the bottom center of the container. Ultrasonic transceiver 108 is electrically connected, such as via electrical connector 118, to LED bank 120. LED bank 120 contains one or more LEDs 122.

In use, the ultrasonic transmitter 108 in FIG. 1 emits a signal transmission 114 (a sound wave or vibration with frequency greater than the upper limit of human auditory perception) toward the feed level. Simultaneously with the transmission of ultrasound transmission 114, the ultrasonic transceiver 108 (or other suitable electronics as known in the art, such as a microprocessor) will begin a timer. After a short period, the ultrasound transmission 114 will intersect the feed 104. The ultrasound transmission 114 will reflect back towards the ultrasonic receiver 112 as ultrasound reflection 116. Once the ultrasound reflection reaches the ultrasonic receiver 112, the ultrasonic transceiver 108 (or other suitable electronics as known in the art, such as a microprocessor) will end the timer. Ultrasonic transceiver 108 (or other suitable electronics as known in the art, such as a microprocessor) uses the elapsed time between transmission of ultrasound transmission 114 and receipt of ultrasound reflection 116 to compute the distance from ultrasonic transceiver 108 to feed 104. This computation is performed using the elapsed time, and the speed of sound, which is a known quantity. Other sensors may also be utilized, such as sensors that include laser and/or infrared. Sensor(s) may be positioned at or near the top of the container; however, one or more sensors could be positioned elsewhere, such as along a sidewall of the container.

Looking still at FIG. 1, once the distance from ultrasonic transceiver 108 to feed 104 is determined, the distance is converted to a value for a feed level. The feed level value is sent to LED bank 120. Alternatively, the feed level value can be determined within LED bank 120. In one embodiment, a microprocessor or microcontroller (and associated electronics, as are well-known in the art) can be used to calculate the level of the feed in the feeder. In this embodiment, the microprocessor is connected to the ultrasonic transceiver, and may receive as an input data related to the distance from the ultrasonic transceiver to the feed level, and compute the feed level based on the distance. The microprocessor may then cause the LEDs to become lit or unlit to correspond to the feed level. For a higher feed value, the majority (or all) of LEDs 122 are lit. For a lower feed value, few (or none) of LEDs 122 are lit. Intermediate feed level values result in an intermediate number of LEDs 122 being lit. LEDs 122 can be any color; in the present embodiment, the LEDs are uniformly green. In this way, a user of the apparatus can quickly, easily, and safely determine the amount of feed in feeder container 100, simply by looking at LED bank 120. In one embodiment, the apparatus is adjustable so that the apparatus can be adapted for use on feeder containers of varying dimensions.

In another embodiment, a strip of LEDs can be positioned between an upper part of the container and a lower part of the container. In one embodiment, the strip may be lined with LEDs at given intervals and adhered to the inside of the container. A photo sensor is placed near the top of the container, such as 180 degrees offset from the LED strip. The photo sensor could be a photovoltaic cell, photodiode, photoresistor, or the like, as is known in the art. As the feed level in the container decreases, the LEDs would be uncovered individually. As each LED is uncovered, the intensity of light collected by the photo sensor will be higher. The change in the intensity of light collected by the photo sensor can be used to determine the feed level in the container. For example, a lower intensity of light collected by the photo sensor would indicate that fewer LEDs are uncovered, indicating a higher level of feed in the container. Conversely, a higher intensity of light collected by the photo sensor would indicate that more LEDs are uncovered, indicating a lower level of feed in the container. The feed value can then be output as discussed herein.

In another embodiment, as seen in FIG. 6, a retractable cord 602 can be installed in feeder container 600 with a variable resistor 604 at the bottom of the vessel. A plate system 606 is used at the top of the feed level and, as the feed 608 is dispensed, the retractable cord 602 would be retracted in proportion to the level of the feed 608, thereby adjusting the resistivity of the variable resistor 604. The resistivity of the variable resistor 604 would correspond with a value for the position of the plate 606, that can be calculated as a feed level. Alternatively, the apparatus will also work if the retractable cord 602 is installed at the top of the feeder. In each embodiment, the feed value can be output as discussed herein.

In another embodiment, as seen in FIG. 7, a weight or load sensor 702 (such as an electronic scale, strain gauge, or other scale, as is known in the art) can be positioned at the bottom of the feeder container 700. The weight or load sensor 702 senses the weight of the feed 704 placed upon it. The measurement can be correlated with a feed level. For example, a higher measurement from the weight or load sensor 702 would indicate a higher level of feed. Conversely, a lower measurement from the weight or load sensor 702 would indicate a lower level of feed. After the feed level is determined, the feed value can be output as discussed herein.

FIG. 2 shows a close-up view of LED bank 200. In this embodiment, LED bank 200 is shown as having 10 LEDs, 202-220. The actual number of LEDs is arbitrary; any number can be chosen. In this embodiment, LEDs 202-206 are red LEDs. LEDs 208-214 are yellow LEDs, and LEDs 216-220 are green LEDs. Other colors of LEDs are acceptable for use with the present invention. Red, green, and yellow are merely an example of possible colors. Red LEDs 202-206 are lit or flashing when the feed level value is low. Of course, if the feeder is “empty,” the LEDs may be unlit, flashing, or otherwise illuminated in some fashion. One or more yellow LEDs 208-214 are lit when the feed level value is intermediate. One or more green LEDs 216-220 are lit when the feed level value is high. In use, as the level of feed in the feeder container is reduced, the LEDs in FIG. 2 would sequentially become unlit, starting from the right side. For example, if the feeder container is full of feed, all of the LEDs would be lit. Then, as feed is dispersed and the feed level lowers, LED 220 would become unlit. As more feed is dispersed and the feed level lowers even further, LED 218 would be unlit. This process would continue until each of the LEDs be unlit. Thus an individual may readily determine the amount of feed simply by viewing the colors of the lit LEDs. Other approaches to representing the feed level are also contemplated by the inventions disclosed herein. For example, LED bank 200 could be replaced or augmented with a liquid crystal display (“LCD”) screen. FIG. 8 shows LCD screen 802 connected to feeder container 800 and displaying the feed level. The LCD screen can display graphically and/or textually the amount of feed available in the feeder container. Further, in a preferred embodiment, the device may be in an “off” state and only activate once a day (or any other desired periods). In this embodiment, the sensor would send and receive the signals once a day (or other period), thereby conserving energy from the energy source, such as a battery. In another preferred embodiment, the LED display can remain in an “off” state, until activated, again to conserve energy. The display may also be remote from the feed container.

FIG. 3 is a close-up representation of an ultrasonic transceiver 300. Ultrasonic transceiver 300 includes ultrasonic transmitter 302 and ultrasonic receiver 304. In this embodiment, ultrasonic transceiver 300 also includes power supply 306. Power supply 306 can be a battery, a connection to a solar panel, an AC power connection, or any other source of electricity as is known in the art. However, the sensor 108, as further exemplified as ultrasonic transceiver 300 does not need to have power supply 306 as part of the sensor. As indicated above, a variety of power supplies may be utilized, as may be their location.

The feed level can also be transmitted via a wireless or hard-wired data connection. FIG. 4 shows transmission utilizing wireless signals 408. Feeder container 400 is equipped with a feed measuring device, as discussed above. The level of feed may be indicated using LED bank 402. The feed measuring device is also equipped with communication device 404 that can include antenna 406. Communication device 404 sends and receives wireless signals 408, such as through wireless antenna 406, to and from a cellular tower, server, or other transmission infrastructure as is known in the art. Alternatively, communication device 404 could be an Ethernet connection using a network interface card, a Blue Tooth connection, a WiFi connection, or any other network interface device. In one embodiment communication device 404 communicates with an Internet access point, server, or router such that communication device 404 can communicate via the Internet. However, communication device 404 can also communicate with a remote device without accessing the Internet. Communication device 404 may be capable of transmitting the feed level to a remote user. In one embodiment, the remote user can configure the frequency of the transmission, or alternatively, send a request to receive information related to the feed level. This information can be sent as an email, an SMS message, a “tweet,” via Twitter™, via Facebook™ message, web page, or other type of communication. Other messaging types as known in the art are available, as well. This enables an individual to remotely monitor the level of feed in the feeder.

A two-way connection using wireless signals 408 enables the apparatus to receive instructions from a remote user, using a desktop computer or cellular phone, for example. With reference to FIG. 4, a remote user can use an app to instruct the apparatus to dispense feed or to change the frequency and duration of dispersing the feed. In such a configuration, the apparatus that dispenses the feed (such as the motor and the associated hardware and/or software) will be connected to the communication device 404. The user's request may also be transmitted via the Internet, with said request being received by communication device 404. The apparatus processes this request and actuates feed dispenser motor 410. In response to this, in one embodiment feed is scattered by rotating disk 412. The duration of actuation can be configured by the remote user.

In another embodiment, multiple feeders can be linked together to share a common communication connection. In still another embodiment, weather sensing station 414 reports weather conditions such as temperature, wind speed, and humidity to communication device 404. Communication device then transmits the weather conditions to the remote user. In another embodiment, a camera (including cameras capable of video images, as well as still pictures) can be connected (wirelessly or hard-wired) to the system. Communication device 404 can transmit video (including pictures) of the area surrounding the feeder container 400 or the feeder area, either upon request from a remote user or automatically. In one embodiment, the camera is activated via a motion detector.

In another embodiment, the apparatus includes security features, to prevent interference with the feeder by undesired wildlife or people. In FIG. 5, undesired wildlife 512 is near feeder container 500. In this embodiment, the ultrasonic transceiver, LED bank 502, communications device 504, and wireless antenna 506 may be present as in the other embodiments described herein. This embodiment further includes tamper sensor 514, tamper light 508, and siren 510. Tamper sensor 514 may include a tilt sensor that senses if feeder container 500 is tilted from its normal position, motion sensor, or other such sensors as are known in the art. Tilt sensors are commonly known in the art, and include level sensor that consists of mercury (or other conductive fluid) that completes or breaks a circuit if tilted too far from level. The tamper sensor could also be a common automotive-type alarm shock sensor, that can be employed to detect sharp impacts to the feeder frame. Alternatively, a motion sensor, such as a passive infrared alarm sensor (such as might be found in a residential building) can be employed to detect any human or animal movement in the area of the feeder. In the event that undesired wildlife 512 disturbs the tamper sensor, the apparatus can be configured to flash lights 508 and/or activate an audible siren 510 or send a notification to a remote user. Any activations of the alarm system may result in a notification being transmitted via communication device 504 to a remote user, as described above.

FIG. 9 depicts a flow chart illustrating the flow of an algorithm for determining the feed level. In step 900, the sensor is initialized. In step 902, the sensor emits a signal, such as an ultrasonic signal. In step 904, an internal timer is started at the sensor. In step 906, the sensor waits to receive a reflected signal, such as a reflected ultrasonic signal. In step 908, a determination is made as to whether the sensor has received a reflected signal. If no signal has been received by the sensor within a certain time period, the sensor may emit another signal in step 902. If a reflected signal is received by the sensor, then the timer ends in step 910 and a time value, such as in milliseconds, is recorded. In step 912, the distance from the sensor to the feed is calculated using the time value. In step 914, the distance from the sensor to the feed is correlated with a feed level. In step 916, the apparatus determines whether LEDs must be lit or unlit based on the feed level. If LEDs must be lit or unlit, then in step 918, the LEDs will be lit or unlit to correspond to the feed level. If the feed level is unchanged, and no additional LEDs need to be lit or unlit, then step 918 is skipped. In step 920, the apparatus determines whether the process should be repeated. If so, then the sensor will emit another signal in step 902. Otherwise, the apparatus ends the process at step 922. This is merely an exemplary algorithm and is not intended to be limiting in any way. Other algorithms are contemplated in this invention.

The present disclosure describes several embodiments of the invention. However, the invention is not limited to these embodiments. Other variations are contemplated to be within the spirit and scope of the invention and claims.

What is claimed is:

1. An apparatus comprising:
a wildlife feeder having a container adapted for holding wildlife feed;
a feed level sensor positioned to the container and positioned to monitor and measure the level of feed in the container; and
an output connected to the feed level sensor that displays the feed level.

2. The apparatus of claim 1, wherein the output further comprises
a plurality of light emitting diodes.

3. The apparatus of claim 1, wherein the output further comprises
a liquid crystal display.

4. The apparatus of claim 1, further comprising:
a communication device capable of transmitting a feed level value to a remotely-located communication device.

5. The apparatus of claim 5, further comprising a remotely-located communication device with an Internet-based application to output the feed level value.

6. The apparatus of claim 4, further comprising
a remotely-located communication device that receives the feed level value using a software application;
and the software application outputs the feed level value.

7. The apparatus of claim 4, further comprising
a software application that permits control of a feed dispenser attached to said wildlife feeder from signals received from a remotely-located communication device.

8. The apparatus of claim 4, further comprising a remotely-located communication device with
a sensor that determines when undesired wildlife attempt to feed at said wildlife feeder.

9. The apparatus of claim 4, further comprising:
a camera, wherein video of at least one area surrounding said wildlife feeder captured by the camera are transmitted to a remotely-located communication device.

10. A measurement apparatus for determining the feed level in wildlife feeders, comprising:
a transceiver,
said transceiver emitting a signal;
said transceiver receiving at least one reflected signal;
a microprocessor that computes the distance from the transceiver to the feed level;
said microprocessor computing a feed level value;
said microprocessor providing a signal to an output;
Said output indicating the feed level value.

11. The apparatus of claim 10, wherein the output further comprises
one or more light emitting diodes.

12. The apparatus of claim 10, wherein the output further comprises
a liquid crystal display to display the feed level value.

13. The apparatus of claim 10, further comprising:
a communication device that transmits the feed level value to a remotely-located communication device.

14. The apparatus of claim 13, further comprising a remotely-located communication device; and
an Internet-based application to output the feed level value.

15. The apparatus of claim 14, further comprising
said feed level value that is received remotely using a software application;
and the software application outputs the feed level value.

16. The apparatus of claim 13, further comprising
a communication device that receives signals to control the feed dispenser attached to said wildlife feeder.

17. The apparatus of claim 10, further comprising
a sensor connected to an alarm, activated when said sensor detects tampering.

18. The apparatus of claim 13, further comprising
a camera, wherein video of at least one area surrounding said wildlife feeder captured by the camera are transmitted to a remotely-located communication device.

19. The apparatus of claim 10, further comprising
said communication device transmits to a remotely-located communication device a signal to indicate that undesired wildlife is near or attempted to feed at said wildlife feeder.

20. The apparatus of claim 10, further comprising a camera.

21. The apparatus of claim 17, further comprising
said communication device transmits a signal indicating that undesired wildlife is near or attempted to feed at said wildlife feeder.

22. An apparatus comprising:
A feed level sensor, adapted to be mounted within a wildlife feeder and positioned to monitor the level of feed in the container; and
an output connected to the feed level sensor that displays the feed level.

23. The apparatus of claim 4 further comprising
A communication device receiving signals from a remotely-located communication device.

24. Apparatus of claim 1 further comprising a camera.
